(19) United States
(12) Patent Application Publication
(10) Pub. No.: US 2004/0223418 A1
(43) Pub. Date: Nov. 11, 2004

(54) Track jump apparatus for accessing an optical storage medium and position detection method thereof

(76) Inventors: Chao-Ming Huang, Hsinchu Hsien (TW); King-Yin Wang, Hsinchu Hsien (TW); Chi-Hsiang Wang, Hsinchu Hsien (TW)

Correspondence Address: BIRCH STEWART KOLASCH & BIRCH, PO BOX 747, FALLS CHURCH, VA, 22040-0747, US

(21) Appl. No.: 10/659,248

(22) Filed: Sep. 11, 2003

(30) Foreign Application Priority Data
May 9, 2003 (TW) 092112666

(51) Int. Cl. G11B 7/085

(52) U.S. Cl. 369/30.17; 369/30.16

(57) ABSTRACT

A track jump apparatus for accessing an optical record medium and the position detection method thereof. The track jump apparatus moves the light spots of the laser beam from the current track to the object track. The track cross velocity and position are stably and precisely controlled during the track jump operation. When pulling in, the track cross velocity is controlled within the control band of the track servo loop, and the stability of the track servo loop is not affected. With track position detection, the apparatus adopts a hybrid track detection method, which generates the track position according to the linear area of a tracking error signal and a focus sum signal.

### BACKGROUND OF THE INVENTION

1. Field of Invention

The invention relates to a track jump apparatus, and more particularly to an apparatus that controls track jump velocity and position stably and precisely when optical pickup head accessed data recorded on a medium with recording tracks optically.

2. Related Art

With increasing density of optical disks like DVDs and narrower track pitches, a smaller pull-in range of tracking error signal makes pull-in of track jump operation more difficult. Therefore, control of the track cross velocity when pulling-in into a target track becomes more important. If the track cross velocity exceeds the control band of the track servo loop in track following mode, the light spot of the laser beam cannot be positioned at the target track. Another track jump is necessary in this situation, which not only increases the access time, but also influences the stability of the track servo loop in track following mode.

U.S. Pat. Nos. 5,497,360 and 5,566,148 disclose a track jump apparatus for controlling the track cross velocity during track jump operations. A predetermined reference velocity profile and a stabilization controller are adopted to control the track cross velocity such that the error between the track cross velocity and the reference velocity profile is minimized. The method to detect the track cross velocity of the above track jump apparatus uses the tracking error signal and the focus sum signal as sources and calculates the time period of the digitized zero cross signals of the tracking error signal and the focus sum signal to obtain the track cross velocity. The method also includes frequency control for close loop feedback. Because of the frequency control method adopted by U.S. Pat. No. 5,497,360 and 5,566,148, the track cross velocity can be kept very close to the reference velocity profile.

However, some problems still need to be overcome. The track cross velocity is updated only when a zero cross of the digitized zero cross signals is detected. This leads to serious detection delay time. In addition, when the track cross velocity is slower, it results in lower zero cross period of the digitized zero cross signals. Accordingly, the sampling frequency becomes lower so the control band of the track jump apparatus is restricted. At this moment, the track jump apparatus is easily affected by the external disturbance, which is caused by disk eccentricity, a change of slider state or the like.

Besides, since the track cross velocity is not constant, it causes the sampling frequency of frequency control to be inconsistent. Moreover, larger overshoot and larger steady state errors also occur in control of track cross velocity. The track cross velocity cannot be precisely controlled within the control band of the track servo loop in track following mode, so the stability of the track servo loop in track following mode is not always guaranteed and the light spot of the laser beam cannot always be positioned at the target track stably. Therefore, the track jump operation is needed again, which increases the access time. Sometimes, this may affect the stability of the track servo loop in track following mode.

To solve the aforementioned problems, U.S. Pat. No. 6,442,111 discloses a linear position detection method, which utilizes the tracking error signal to detect the relative position between the light spot of the laser beam and the disk tracks. Since, during the track crossing, the relative position between the light spot of the laser beam and the disk tracks changes, sine waved signals or saw-teeth waved signals are produced in the tracking error signal, which are utilized to implement the method disclosed in U.S. Pat. No. 6,442,111. In other words, U.S. Pat. No. 6,442,111 employs the tracking error signal to detect the relative position between the light spot of the laser beam and the disk tracks.

A conversion table, which records the relation of the tracking error signal and the relative position between the light spot of the laser beam and the disk tracks, is established in U.S. Pat. No. 6,442,111 such that the relative position between the light spot of the laser beam and the disk tracks can be obtained from the table by using the tracking error signal during track jump operations. The linear position is obtained at any time for the closed loop control in U.S. Pat. No. 6,442,111. The approach in U.S. Pat. No. 6,442,111 has the advantages of small detection delay time, and constant sampling frequency. Therefore, the track cross velocity can be controlled stably and precisely.

Since the relation between the tracking error signal and the corresponding linear position is non-linear and does not correspond, U.S. Pat. No. 6,442,111 adopts the derivative of the tracking error signal or the focus sum signal to separate the relation between the tracking error signal and the corresponding linear position into three portions such that in each portion the relation between the tracking error signal and the corresponding linear position corresponds one to one. The conversion table records the non-linear variation of the tracking error signal. Even so, some problems still occur.

The apparatus is not easily implemented by analog circuits once the conversion table is adopted, while digital signal processors or digital circuits are more suitable. However, if the digital signal processors or digital circuits are employed to implement the apparatus, the analog to digital converters (A/D converters) are necessary to transform the tracking error signal or the focus sum signal into digital forms. Therefore, the resolution of the A/D converters and the word length of the digital signal processors must be taken into consideration.

In addition, due to the smaller variation in the peak of the tracking error signal and the noise of the tracking error signal, the A/D converters may sample the same tracking error signal at different positions. This causes distortion for the linear position transform. If the resolution of the converters is insufficient, more serious distortion occurs. Such distortion affects the stability of the apparatus in controlling the track cross velocity.

### SUMMARY OF THE INVENTION

The main object of the invention is to provide a track jump apparatus to solve the above-mentioned problems. The apparatus adopts the method of hybrid track position detection to detect the relative position between the light spot of the laser beam and the disk tracks. The disclosed method is not largely affected by the resolution of A/D converters. Since the distortion of the transformed track position is smaller, the track jump apparatus can control the track cross velocity and the track position more stably and precisely when moving the laser spot from the current track to the target track. During pulling-in, the track cross velocity can be controlled within the control band of the track servo loop in track following mode such that the stability of the track servo loop in track following mode can be maintained.

Consequently, the disclosed track jump apparatus includes a position control unit, which has a hybrid track position detector, a position accumulator, a track servo compensator, a position profile generator with a pull-in detector, a subtractor, and a switch. The hybrid track position detector further includes a first offset compensator, a second offset compensator, a first peak detector, a first offset detector, a second peak detector, a second offset detector, a first gain compensator, a second gain compensator, a first gain calculator, a second gain calculator, a hybrid track position calculator, and a register file.

The actuator unit is employed to move an objective lens (in optical pickup head) to change the position of laser spot emitted from the laser diode (in optical pickup head) onto the data tracks of an optical storage medium, then the information corresponding to the data tracks is generated. The pre-amplifier generates a tracking error signal and a focus sum signal according to the information corresponding to the data tracks. The micro processing unit provides a jump command. When the position control unit does not receive the jump command, the laser spot output from the objective lens (in optical pickup head) is positioned at the current track and the position control unit receives the tracking error signal in order to produce a control signal to control the position of the laser spot by means of the actuator unit. When the position control unit receives the jump command, the laser spot output from the objective lens (in optical pickup head) moves from the current track to a target track, and the position control unit receives the tracking error signal and the focus sum signal to generate a control signal to control the track cross velocity and the position of the laser spot.

The disclosed hybrid track position detection method generates the track position according to the linear area portion of the tracking error signal and the focus sum signal. Since the variation of the tracking error signal and the focus sum signal is more obvious in the linear area portion than in the non-linear area portion, it does not lead to the signal distortion caused by the sampling of the A/D converters. The track position with less distortion provides more accurate and more stable feedback signals to the position control unit during track jump operations, thereby moving the light spot of the laser beam from the current track to the target track. Furthermore, when moving the laser spot, the track cross velocity and the track position can be controlled stably and precisely. When pulling-in, the track cross velocity is well controlled within the control band of the track servo loop in track following mode. The light spot of the laser beam can be positioned at the target track. The conversion table is not needed to describe the relationship among the tracking error signal, the focus sum signal and the track position in the disclosed invention.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is the system block diagram of the track jump apparatus of the invention;

FIG. 2 is the system block diagram of the hybrid track position detection unit of the track jump apparatus of the invention;

FIG. 3 shows the principle of the hybrid track position detection unit of the invention;

FIG. 4A and FIG. 4B are the flow charts for the area changeover and the hybrid track position calculation determined by the hybrid track detection unit of the invention;

FIG. 5 is the first experiment data of the track jump apparatus;

FIG. 6 is the second experiment conditions of the track jump apparatus;

FIG. 7 is the second experiment data of the track jump apparatus;

FIG. 8 is the third experiment conditions of the track jump apparatus; and

FIG. 9 is the third experiment data of the track jump apparatus.

### DETAILED DESCRIPTION OF THE INVENTION

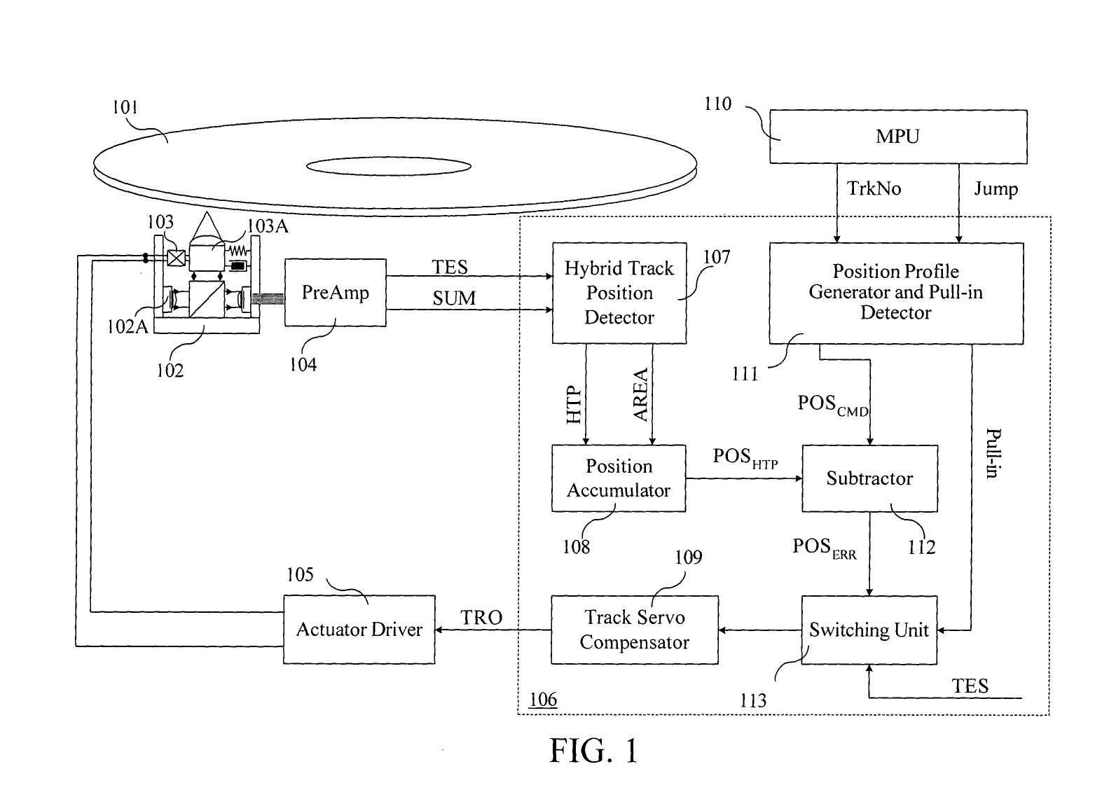

Please refer to FIG. 1, which illustrates the system block diagram of the track jump apparatus of the invention. The disclosed track jump apparatus is applied in the accessing system, which accesses the optical record medium, e.g., DVD-ROM.

The disclosed track jump apparatus in FIG. 1 includes an optical storage medium 101, an optical pickup head 102, an actuator unit 103, a pre-amplifier 104, an actuator driver 105, a position control unit 106 and a micro processing unit (MPU) 110. The position control unit 106 is composed of a hybrid track detection unit 107, a position accumulator 108, a track servo compensator 109, a position profile generator and pull-in detector 111, a subtractor 112 and a switching unit 113. The functionality and operation of the above-mentioned components are described in detail in the following.

The actuator unit 103 moves an objective lens 103A in the optical pickup head 102 which changes the position of light spot emitted from laser diode 102B in the optical pickup head 102 onto data tracks of the optical storage medium 101, thereby generating information corresponding to the data tracks.

The MPU 110 is used to generate a jump command JUMP and a track number of jump TrkNo to the position control unit 106 for changing the state of the switching unit 113 according to the jump command JUMP. When the position control unit 106 does not receive the jump command, the switching unit 113 is switched to an output end, which delivers a tracking error signal. The track servo loop is now at track following mode, and the light spot of the laser beam is positioned at the current track. When the position control unit 106 receive the track jump command, the switch unit 113 is switched to the output end of the subtractor 112. The track servo loop is now in track jump mode. Consequently, the current mode of the track servo loop is determined by whether or not the MPU outputs a track jump command.

The position profile generator and pull-in detector 111 generates an object position profile for a track jump and a pull-in control signal Pull-in for switching the connecting state of the switching unit 113.

While the MPU 110 delivers a track jump command JUMP, the position profile generator and pull-in detector 111 outputs a pull-in control signal of low voltage level accordingly, such that the switching unit 113 is switched to connect with the output end of the subtractor 112. Meanwhile, the position profile generator and pull-in detector 111 produces the object position profile POS_{CMD} according to the track number of jump TrkNo from the MPU 110. The track servo loop is then in track jump mode. The position profile generator and pull-in detector 111 detects whether the light spot of the laser beam arrives the target track. When the light spot reaches the target track, the position profile generator and pull-in detector 111 issues a pull-in signal of high-voltage level such that the switching unit 113 is switched to the output end of the tracking error signal. The track servo loop is now at track following mode, and the light spot of the laser beam is positioned at the target track.

The hybrid track position detector 117 utilizes the tracking error signal TES and the focus sum signal SUM to obtain the track position. Since the detected track position by the hybrid track position detector 117 is corresponding to a single track, a position accumulator 118 must be used to generate an accumulated track position when jumping a plurality of tracks. The hybrid track position detector 107 delivers a hybrid track position signal HTP and an area changeover signal AREA. The hybrid track position signal HTP stands for the current track position. The area changeover signal AREA stands for the corresponding area changeover. The position accumulator 108 determines whether a track cross comes up by utilizing the area changeover signal AREA. When the laser spot starts to cross a track, the internal counter of the position accumulator 108 accumulates the current track position and thereby issues an accumulated hybrid track position signal POS_{HTP} to the subtractor 112.

The accumulated hybrid track position signal POS_{HTP} from the position accumulator 108 and the object position profile POS_{CMD} from the position profile generator and pull-in detector 111 are delivered to the subtractor 112 in order to produce the position error signal POS_{ERR} for track jump operations. The compensator 109 produces a control signal TRO to the actuator driver 105 according to the output of the switching unit 113. The actuator driver 105 transforms the control signal TRO from voltage level to current level, which is delivered to the actuator unit 103 to move the objective lens (in the optical pickup head 102). The laser spot output from the objective lens in the optical pickup head 102 is projected on the optical record medium 101. The photo detector of the pickup head 102 receives the reflected light spot, which is then output to the pre-amplifier 104. The pre-amplifier 104 generates the tracking error signal TES and the focus sum signal SUM accordingly. The focus sum signal SUM is sent to the hybrid track position detector 107. The tracking error signal TES is sent to the hybrid track position detector 107 and the switching unit 113.

The position control unit 106 is in track jump mode after receiving the track jump command from the MPU 110. The control signal TRO is used to minimize the difference between POS_{HTP} (the output of the position accumulator 108) and POS_{CMD} (the output of the position profile generator and pull-in detector 111), thereby moving the light spot of the laser beam from the current track to the target track.

The position control unit 106 in FIG. 1 and its components can be implemented by digital signal processors, e.g. DSP with 100 kHz sampling rate. Additional circuits are not needed to form the circuit.

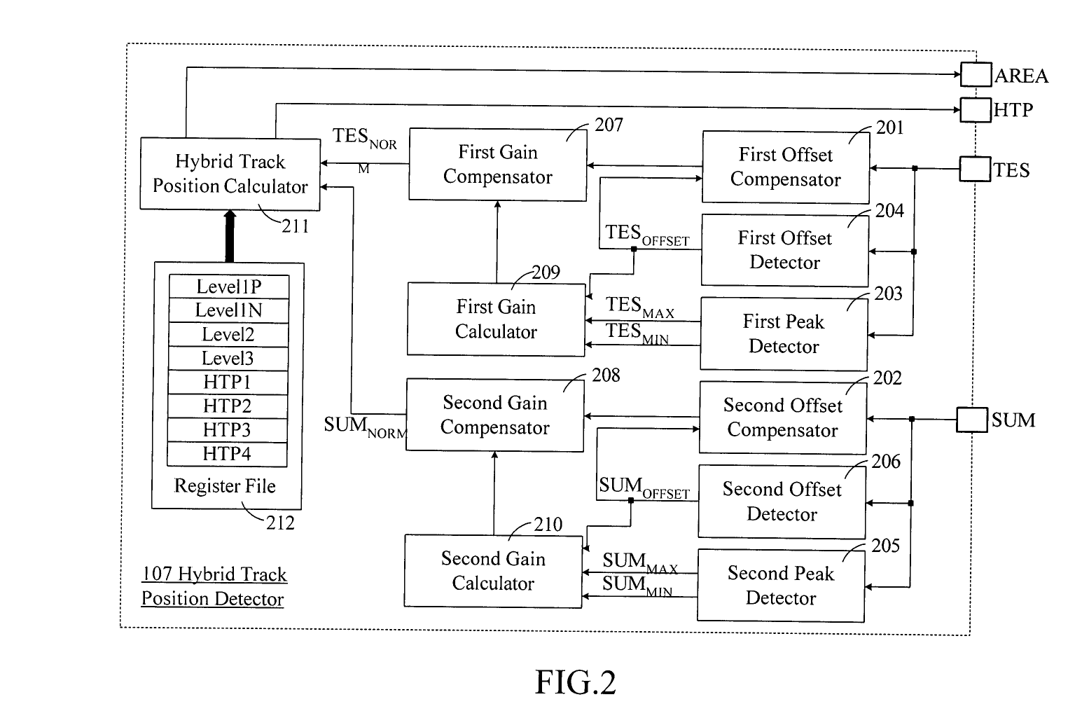

FIG. 2 illustrates the architecture of the hybrid track position detector 107 of the invention. The hybrid track position detector 107 includes a first offset compensator 201, a second offset compensator 202, a first peak detector 203, a first offset detector 204, a second peak detector 205, a second offset detector 206, a first gain compensator 207, a second gain compensator 208, a first gain calculator 209, a second gain calculator 210, a hybrid track position calculator 211, and a register file 212. The word ‘first’ herein is related to the tracking error signal TES, while ‘second’ is related to the focus sum signal SUM.

After activating the focusing servo loop, some sine waves, saw tooth waves or similarities appear in the tracking error signal TES and the focus sum signal SUM due to the track cross. At this moment, the first peak detector 203 and the second peak detector 205 detect the maximum value (TES_{MAX} [symbol] SUM_{MAX}) and the minimum value (TES_{MIN} [symbol] SUM_{MIN}) of the tracking error signal TES and the focus sum signal SUM. The first offset detector 204 and the second offset detector 206 detect the offset of the tracking error signal TES and the focus sum signal SUM, and then deliver a first offset TES_{OFFSET} and a second offset SUM_{OFFSET} to the first offset compensator 201 and the second offset compensator 202, thereby reducing the offset of the tracking error signal TES and the focus sum signal SUM. A signal is generated by the first offset compensator 201 according to the tracking error signal TES and the first offset TES_{OFFSET}, which is delivered to the first gain compensator 207. Another signal is generated by the second offset compensator 202 according to the focus sum signal and the second offset SUM_{OFFSET}, which is delivered to the second gain compensator 208.

The first gain calculator 209 and the second gain calculator 210 compute a first gain value and a second gain value respectively for normalizing the tracking error signal TES and the focus sum signal SUM. The first and second gain value herein are calculated according to the maximum value (TES_{MAX}, SUM_{MAX}) and the minimum value (TES_{MIN},SUM_{MIN}) from the first peak detector 203 and the second peak detector 205, and the first offset value TES_{OFFSET} from the first offset detector 204 and the second offset value SUM_{OFFSET} from the second offset detector 206. The first gain value and the second gain value are then sent to the first gain compensator 207 and the second gain compensator 208. The first gain compensator 207 generates a normalized tracking error signal TES_{NORM} accordingly, while the second gain compensator 208 generates a normalized focus sum signal SUM_{NORM} to the hybrid track position calculator 211. The hybrid track position calculator 211 then delivers an area changeover signal AREA and a hybrid track position signal HTP. The register file 212 stores the necessary parameters of the hybrid track position calculator 211, which are Level1P, Level1N, Level2, Level3, HTP1, HTP2, HTP3, and HTP4. The hybrid track position calculator 211 finally generates the actual track position for the track jump apparatus.

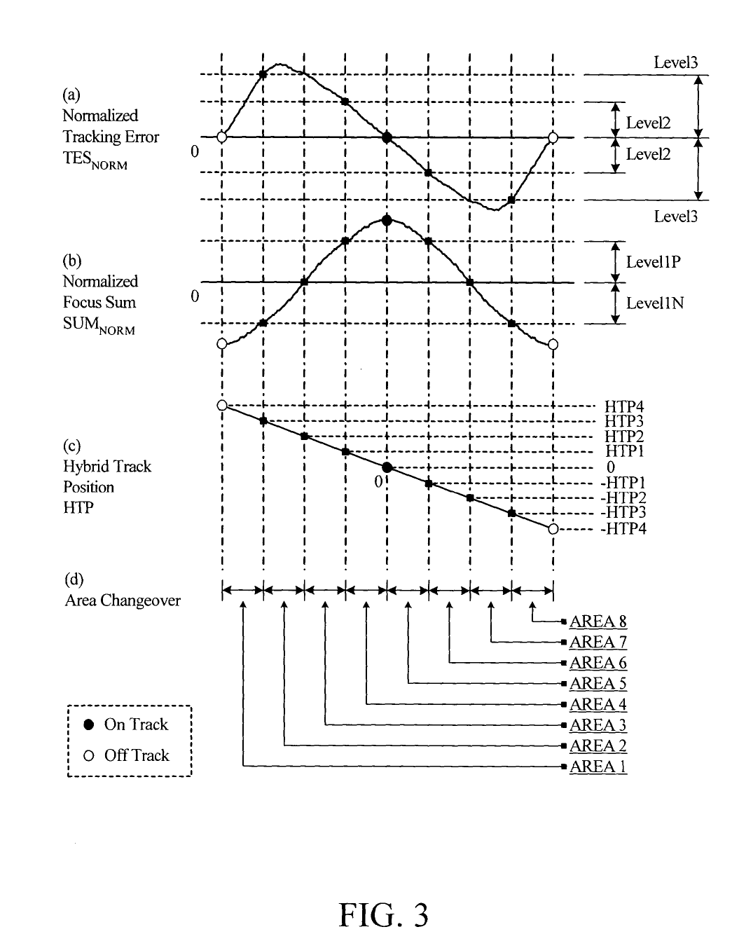

FIG. 3 illustrates the principle of the disclosed hybrid track position detector. The figure mainly shows the relationship among the normalized tracking error signal, the normalized focus sum signal, the hybrid track position, and the corresponding area changeover. Part (a) illustrates the normalized tracking error signal, while part (b) illustrates the normalized focus sum signal. Part (c) stands for the hybrid track position. Part (d) is the corresponding area changeover, which is AREA1 to AREA8.

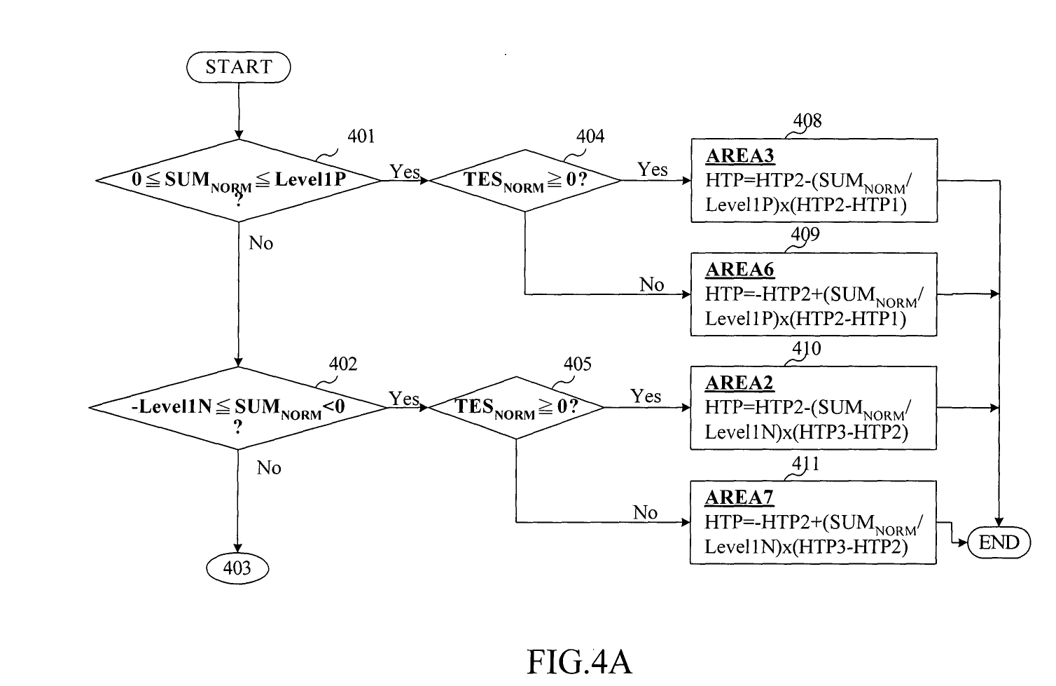

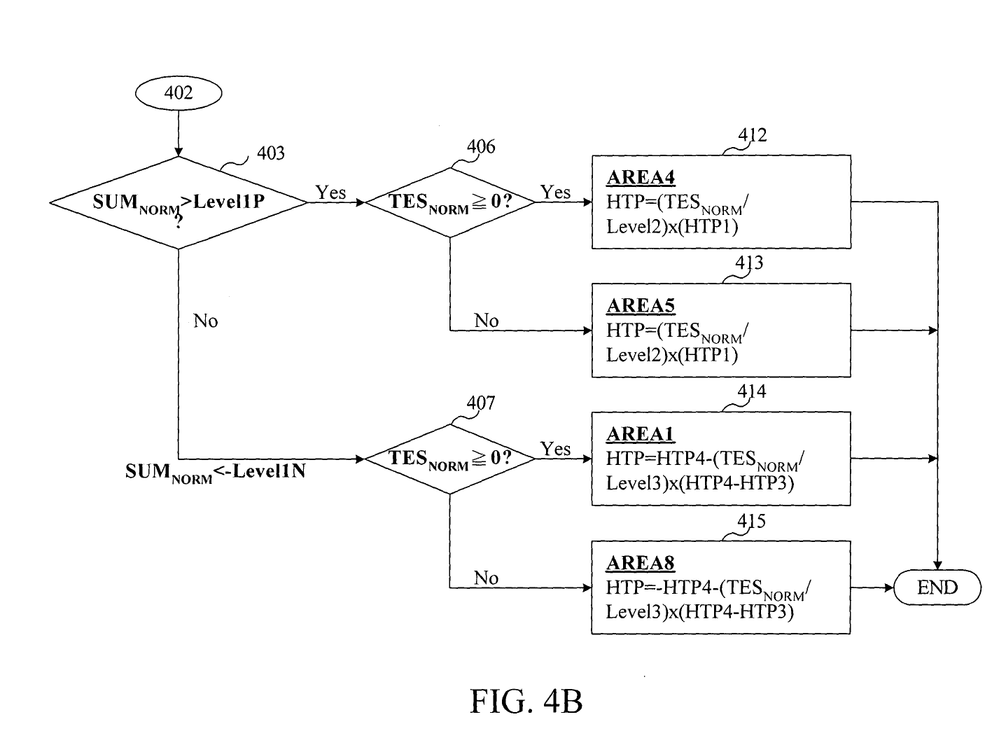

The linear area is observed clearly from the figure. In AREA1, AREA4, AREA5, and AREA8, the relation between the normalized tracking error signal TES_{NORM} and the hybrid track position is nearly linear, while in AREA2, AREA3, AREA6, and AREA7, the normalized focus sum signal SUM_{NORM} and the hybrid track position is nearly linear. Therefore, the design of the hybrid track position calculator 211 is based on the linear relationship shown in FIG. 3 and is implemented by digital signal processors. The approach is illustrated in FIG. 4.

The hybrid track position of on track is set as ‘0’, while the hybrid track position of off track is HTP4 or −HTP4. The computation in FIG. 4 is obtained according to the area changeover relation in FIG. 3(d). After obtaining the normalized tracking error signal and the normalized focus sum signal, the first stage of area changeover is determined according to the normalized focus sum signal and the pre-determined relationship of Level 1P and Level1N.

The first stage is to determine whether the normalized focus sum signal SUM_{NORM} is in the linear area, which is AREA2, AREA3, AREA6, and AREA7. This stage is performed in steps 401 to 403, which are described as follows.

First, the flow starts by determining whether the normalized focus sum signal SUM_{NORM} is between 0 and Level1P. In step 401, if the normalized focus sum signal SUM_{NORM} is between 0 and Level1P, the signal is likely in AREA3 or AREA6. If the signal is not in those two areas, the flow goes to step 402.

It follows to determine whether the normalized focus sum signal SUM_{NORM} is between 0 and −Level1N. In step 402, if the normalized focus sum signal SUM_{NORM} is between 0 and −Level 1N, the signal is likely in AREA2 or AREA7, otherwise the flow goes to step 403.

Then, the flow determines whether the normalized focus sum signal SUM_{NORM} is greater than Level1P. In step 403, if the normalized focus sum signal SUM_{NORM} is greater than Level1P, then the flow goes to step 406 and the signals may lie in AREA4 or AREA5. Otherwise, the normalized focus sum signal SUM_{NORM} is less than −Level 1N and the signals may lie in AREA1 or AREA8. The flow then goes to step 407. The area changeover decision using the normalized focus sum signal is now finished.

After finishing the first stage, the second stage of area changeover is then executed according to the normalized tracking error signal TES_{NORM}. In the second stage, the area is obtained by determining whether or not the normalized tracking error signal TES_{NORM} is positive.

In step 404, if the normalized tracking error signal TES_{NORM} is greater than or equal to 0, the flow goes to step 408, and the area changeover is AREA3. The track position is computed by the formula: HTP=HTP2−(SUM_{NORM}/Level1P)×(HTP2−HTP1) in step 408. Otherwise, the step goes to step 409, and the area changeover is AREA6. The track position is computed by the formula: HTP=−HTP2+(SUM_{NORM}/Level1P)×(HTP2−HTP1) in step 409.

In step 405, if the normalized tracking error signal TES_{NORM} is greater then or equal to 0, the flow goes to step 410, and the area changeover is AREA2. The track position is obtained from the formula: HTP=HTP2−(SUM_{NORM}/Level1N)×(HTP3−HTP2) in step 410. Otherwise the flow goes to step 411, and the area changeover is AREA7. The track position is computed by the formula: HTP=−HTP2+(SUM_{NORM}/Level1N)×(HTP3−HTP2) in step 411.

In step 406, if the normalized tracking error signal TES_{NORM} is greater then or equal to 0, the flow goes to step 412, and the area changeover is AREA4. The track position is obtained from the formula: HTP=(TES_{NORM}/Level2)×(HTP1) in step 412. Otherwise the flow goes to step 413, and the area changeover is AREA5. The track position is computed by the formula: HTP=(TES_{NORM}/Level2)×(HTP1) in step 413.

In step 407, if the normalized tracking error signal TES_{NORM} is greater then or equal to 0, the flow goes to step 414, and the area changeover is AREA1. The track position is obtained from the formula: HTP=HTP4−(TES_{NORM}/Level3)×(HTP4−HTP3) in step 414. Otherwise the flow goes to step 415, and the area changeover is AREA8. The track position is computed by the formula: HTP=−HTP4−(TES_{NORM}/Level3)×(HTP4−HTP3) in step 415.

From the detailed description above, the components and the operation of the invention are very clear and easily understood. Three sets of experimental data are provided in the following as evidence of the effectiveness of the disclosed invention.

[symbol] Experiment I

[symbol]

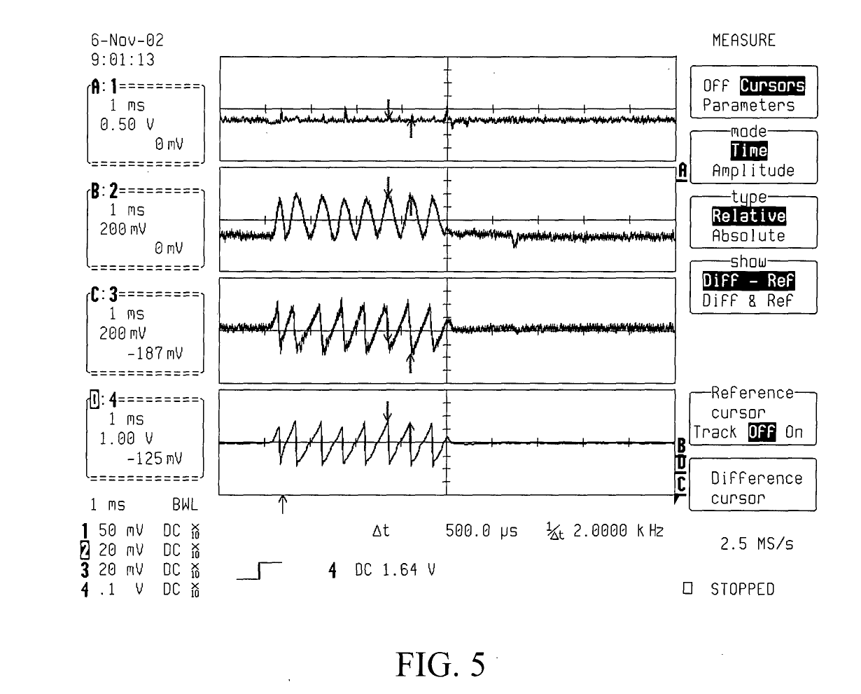

FIG. 5 is the first experimental data of the track jump apparatus. The track number of jump is eight. The object position profile adopted in this track jump experiment is generated from a constant velocity command. The desired track cross velocity is 2 kHz(tracks/msec). The main object of experiment I is to test whether there is distortion of the track position generated by the hybrid track position detector 107. The waveform of Part (a) is the output of the compensator 109. The waveform of Part (b) stands for the focus sum signal. The waveform of Part (c) stands for the tracking error signal, while the wave form of Part (d) is the track position.

From FIG. 5, the track cross velocity is precisely controlled at 2 kHz (tracks/msec). The overshoot of pull-in is very small, and the light spot is also precisely positioned at the target track. The distortion of the track position is also very small. Small overshoot in tracking error signal implies that the track cross velocity and the track position are controlled precisely within the control band of the track servo loop when pulling-in to the track following operation. Therefore, the stability of the track servo loop in track following mode can be maintained. The light spot of the laser beam is accurately positioned at the target position.

[symbol] Experiment II

[symbol]

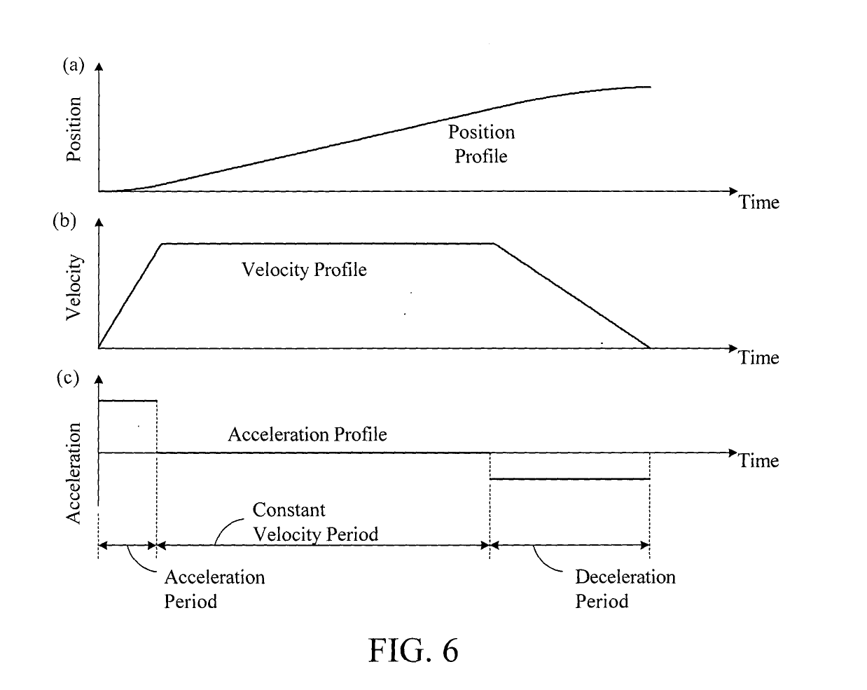

It jumps 255 tracks five times continuously in experiment II. The tested DVD-ROM disk is ABEX TDR-813, whose disk eccentricity is 150 μm. The main object of experiment II is to test disturbance reject ability to external disturbances, e.g., the eccentricity of the disks, or change the friction of the pickup head machinery. The test conditions of experiment II are shown in FIG. 6. There are three test periods, which are the acceleration period, constant velocity period, and deceleration period. Part (c) shows the acceleration values of the three test periods. The vertical axis is acceleration, while the horizontal axis is time. The acceleration values in the acceleration period and the deceleration period may be adjusted according to the track number of jump and the characteristics of the actuator unit 103. Part (b) is the velocity value generated according to Part (c). The vertical axis is velocity, and the horizontal axis is time. Since the position control unit 106 is implemented by the digital signal processor, and the sampling rate is 100 kHz, the bandwidth of the hybrid track position detector 107 is restricted. The highest track cross velocity that may be detected currently is about 35 kHz(tracks/mesc). Therefore, the velocity of part (b) has to satisfy the restrictions. Part (a) is the track position generated according to Part (b). The vertical axis is position, and the horizontal axis is time.

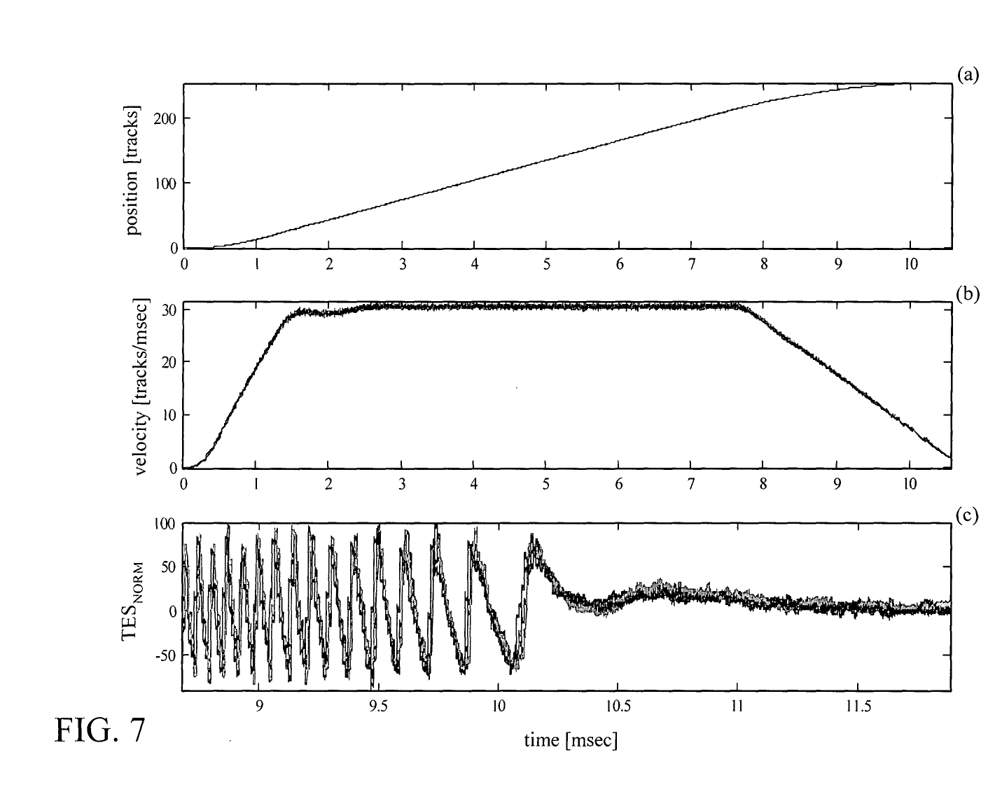

FIG. 7 is the second experiment data of the track jump apparatus. Part (a) is the overlap of position output of the five continuous 255-track jumps. Part (b) is the overlap of the velocity, while part (c) is the overlap of pulling-in condition of the five track jumps. The max track jump time is 10.5637 msec. The min track jump time is 10.5581 msec. The average tack jump time is 10.5604 msec. The max peak track crossing velocity is 31.5059 kHz(tracks/msec). The min peak track crossing velocity is 31.3100 kHz(tracks/msec). The max final track cross velocity is 2.0493 kHz(tracks/msec). The min final track cross velocity is 1.9279 kHz(tracks/msec).

As shown in FIG. 7, the track jump is very stable in the disclosed track jump apparatus with external disturbances. The light spot is stably positioned at the target track position. Not only the overshoot of pull-in is very small, but also the repeatability for each track jump is satisfactory.

[symbol] Experiment III

[symbol]

It jumps 7 tracks five times continuously in experiment 111. The tested DVD-ROM disk is ABEX TDR-813, whose disk eccentricity is 150 μm. The main object of experiment III is to test the disturbance rejection ability against the disk eccentricity.

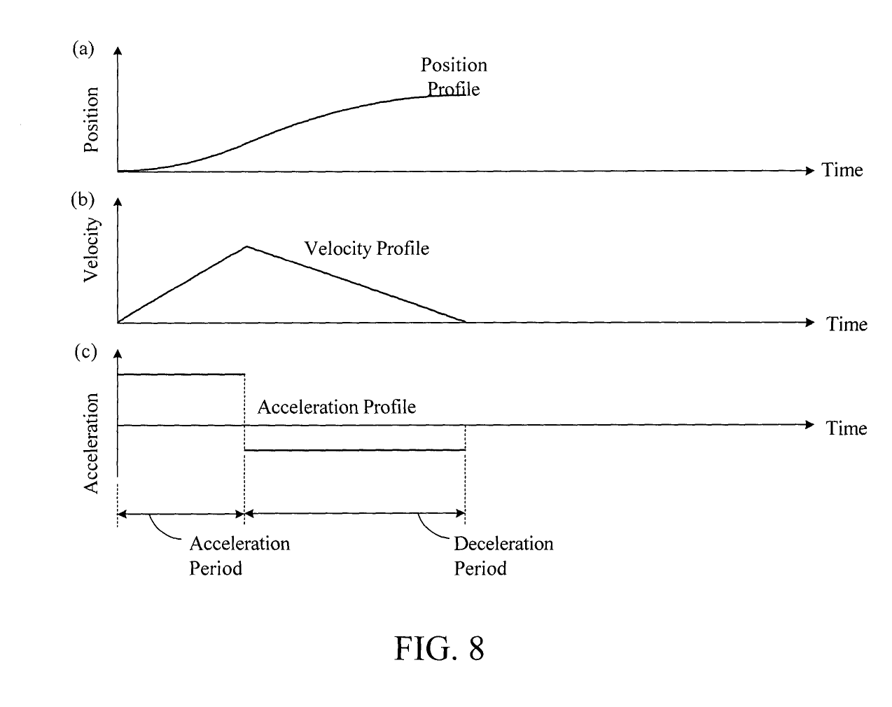

The test conditions of experiment III are shown in FIG. 8. Because the track number of jump is less, the track cross velocity in Experiment III do not exceed the detection bandwidth of the hybrid track position detector 107. Consequently, there are only two test periods, which are the acceleration period and deceleration period. Part (c) shows the acceleration values of the two test periods. The vertical axis is acceleration, while the horizontal axis is time. The acceleration values in the acceleration period and the deceleration period may be adjusted according to the track number of jump and the characteristics of the actuator unit 103. Part (b) is the velocity value generated according to Part (c). The vertical axis is velocity, and the horizontal axis is time. Since the position control unit 106 is implemented by the digital signal processor, and the sampling rate is 100 kHz, the bandwidth of the hybrid track position detector 107 is restricted. The highest track cross velocity that may be detected currently is about 35 kHz(tracks/mesc), which the velocity of part (b) must match. Part (a) is the track position generated according to Part (b). The vertical axis is position, and the horizontal axis is time.

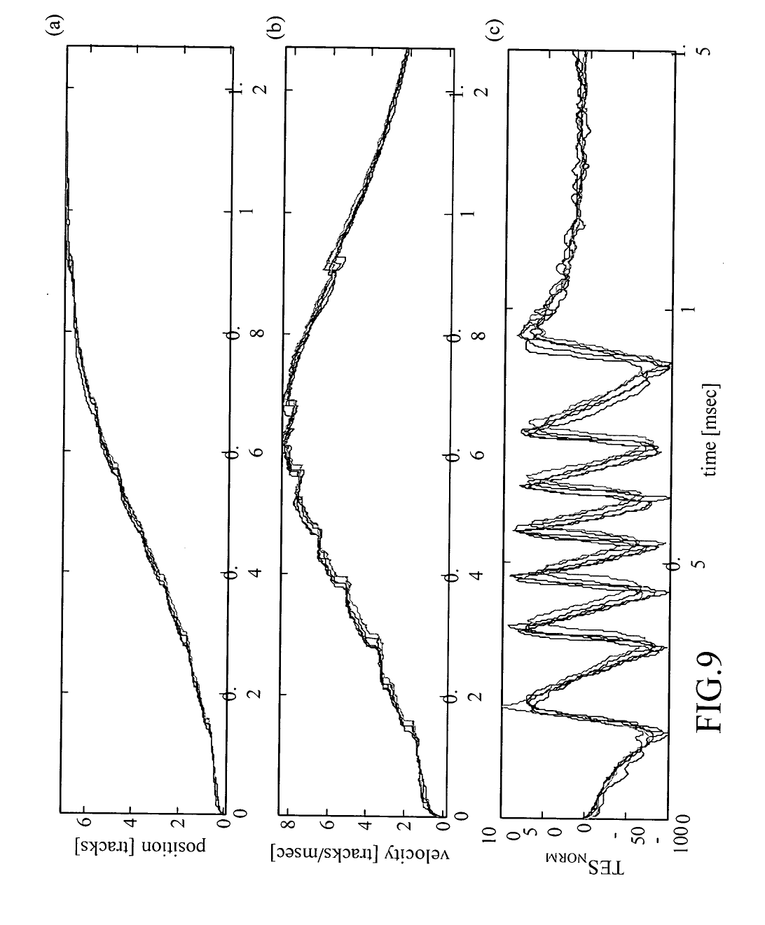

FIG. 9 is the data of experiment III of the track jump apparatus. Part (a) is the overlap of position output of the five continuous 7-track jumps. Part (b) is the overlap of the velocity, while part (c) is the overlap of pulling-in condition of the five track jumps. The max track jump time is 1.2751 msec. The min track jump time is 1.2670 msec. The average track jump time is 1.2701 msec. The max peak track cross velocity is 8.5188 kHz (tracks/msec). The min peak track cross velocity is 8.2937 kHz (tracks/msec). The max final track cross velocity is 2.2246 kHz (tracks/msec). The min final track cross velocity is 2.1024 kHz (tracks/msec).

Even with external disturbances, the experiment data in FIG. 9 shows that the disclosed apparatus has stable track jump characteristics, with small overshoot while pulling-in. The light spot is stably positioned at the target track. The repeatability for each track jump is satisfactory.

The conversion table is not necessary in the disclosed method to describe the relation among the tracking error signal, the focus sum signal, and the track position. The necessary parameters are Level1P, Level1N, Level2, Level3, HTP1, HTP2, HTP3, and HTP4. Because the specification of DVD disk is more conscientious, and the variation of the track pitch is also very small, besides, the tracking error signal and the focus sum signal are normalized after received by the hybrid track position detector 107, the necessary parameters need not be revised once placing another DVD disk into the disclosed track jump apparatus.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A track jump apparatus for accessing an optical storage medium, which is applied for controlling track cross velocity and track position, comprising:
an actuator unit for moving an objective lens in an optical pickup head which changes the position of light spot emitted from laser diode in the optical pickup head onto data tracks of the optical storage medium, thereby generating information corresponding to the data tracks;
a pre-amplifier for generating a tracking error signal and a focus sum signal according to the information corresponding to the data tracks;
a micro processor for providing a track jump command; and
a position control unit electrically coupled to the pre-amplifier and the micro processor, wherein when the position control unit does not receive the jump command, the laser spot output from the objective lens in the optical pickup head is positioned at the current track and the position control unit receives the tracking error signal in order to produce a control signal to control the position of the laser spot, and when the position control unit receives the jump command, the laser spot output from objective lens in optical pickup head moves from the current track to a object track, and the position control unit receives the tracking error signal and the focus sum signal to generate a control signal to control the track cross velocity and the position of the laser spot by means of actuator unit.

2. The track jump apparatus of claim 1, wherein the actuator unit is controlled by electric current.

3. The track jump apparatus of claim 2, wherein the track jump apparatus further comprises an actuator driver for transforming the control signal from voltage type to current type.

4. The track jump apparatus of claim 1, wherein the position control unit comprises:
a hybrid track position detector for delivering a hybrid track position signal and an area changeover signal according to the tracking error signal and the focus sum signal;
a position accumulator for computing the current accumulated hybrid track positions according to the hybrid track position signal and the area changeover signal, thereby delivering an accumulated hybrid track position signal;
a position profile generator and pull-in detector for generating an object position command signal and a pull-in signal according to the track jump command, wherein the object position command signal and the pull-in signal are necessary for moving the light spots of the laser beam from the current track to the object track;
a subtractor for delivering a position error signal according to the accumulated hybrid track position signal and the object position command signal; and
a switching unit for receiving the tracking error signal or the position error signal according to the voltage level of the pull-in signal.

5. The track jump apparatus of claim 4, wherein the position control unit further comprises a compensator for delivering the control signal to the actuator driver.

6. The track jump apparatus of claim 4, wherein the hybrid track position detector comprises:
a register file for storing the corresponding parameters for computing hybrid track position; and
a hybrid track position calculator for delivering the hybrid track position signal and the area changeover signal according to a normalized tracking error signal, a normalized focus sum signal, and the parameters.

7. The track jump apparatus of claim 6, wherein the hybrid track position detector further comprises:
a first gain calculator, for computing a gain value which is necessary for normalizing a tracking error signal according to a offset of the tracking error signal, and a maximum value and a minimum value of the tracking error signal;
a second gain calculator, for computing a gain value which is necessary for normalizing a focus sum signal according to a offset of the focus sum signal, and a maximum value and a minimum value of the focus sum signal;
a first gain compensator, for delivering the normalized tracking error signal according to the gain value of the tracking error signal and an offset compensated tracking error signal; and
a second gain compensator, for delivering the normalized focus sum signal according to the gain value of the focus sum signal and an offset compensated focus sum signal.

8. The track jump apparatus of claim 7, wherein the hybrid track position detector further comprises:
a first peak detector for detecting the maximum and the minimum of the tracking error signal;
a second peak detector for detecting the maximum and the minimum of the focus sum signal;
a first offset detector for delivering the offset of the tracking error signal according to the tracking error signal; and
a second offset detector for delivering the offset of the focus sum signal according to the focus sum signal.

9. The track jump apparatus of claim 7, wherein the track position detector further comprises:
a first offset compensator for delivering the offset compensated tracking error signal according to the offset of the tracking error signal; and
a second offset compensator for delivering the offset compensated focus sum signal according to the offset of the focus sum signal.

10. The track jump apparatus of claim 4, wherein the area changeover signal is delivered when the relation of the normalized tracking error signal and the normalized focus sum signal is linear.

11. A position detection method for a track jump apparatus which accesses an optical storage medium, which method is applied for controlling track cross velocity and track position, wherein the apparatus comprises an optical pickup head to project light spots on data tracks of the optical storage medium, thereby generating information corresponding to the data tracks, the method comprising the steps of:
outputting a tracking error signal and a focus sum signal by a pre-amplifier according to the information corresponding to the data tracks, thereby delivering a hybrid track position signal and an area changeover signal by a hybrid track position detector;
providing a track jump command by a micro processor, and outputting an object position command signal and a pull-in signal according to the track jump command;
outputting an accumulated hybrid track position signal according to the object position command signal and the area changeover signal;
outputting a position error signal according to the accumulated hybrid track position signal and the object position command signal; and
outputting a control signal for controlling the track cross velocity of the laser spot emitted from optical pickup head by a compensator according to the voltage level of the pull-in signal.

12. The position detection method for a track jump apparatus of claim 11, wherein the step of delivering a hybrid track position signal and an area changeover signal further comprises steps of:
obtaining an offset value, a maximum value and a minimum value according to the tracking error signal;
obtaining an offset value, a maximum value and a minimum value according to the focus sum signal;
outputting a gain value according to the offset value, the maximum value and the minimum value according to the tracking error signal;
outputting a gain value according to the offset value, the maximum value and the minimum value according to the focus sum signal;
outputting a normalized tracking error signal according to the gain value and the offset of the tracking error signal; and
outputting a normalized focus sum signal according to the gain value and the offset of the focus sum signal.

13. The position detection method for a track jump apparatus of claim 12, wherein the area changeover signal is delivered when the relation of the normalized tracking error signal and the normalized focus sum signal is linear.
